(19) United States
(12) Patent Application Publication
(10) Pub. No.: US 2011/0079688 A1
(43) Pub. Date: Apr. 7, 2011

(54) Folding TV stand assembly

(76) Inventor: James E. Grove, Marina Del Rey, CA (US)

(21) Appl. No.: 12/587,092

(22) Filed: Oct. 2, 2009

(51) Int. Cl. F16M 11/00

(52) U.S. Cl. 248/176.3

(57) ABSTRACT

A folding TV stand assembly adapted to be shipped disassembled in a substantially-flat configuration within a compact shipping container and assembled without the use of tools. The TV stand assembly includes a rotatable shelf support, a TV mount to be connected to the back of a television, and an upstanding back spine to be removably received at one end thereof by a spine-receiving base of the rotatable shelf support and detachably connected at the opposite end thereof to the TV mount. The shelf support has first and second sets of rails that are pivotally coupled to respective opposite sides of the spine-receiving base. The first and second sets of rails are rotatable relative to the spine-receiving base between an unfolded position projecting outwardly and away from one another to a folded position arranged in parallel alignment with one another to facilitate transport in the substantially-flat shipping configuration. A plurality of shelves are detachably connected to the sets of rails of the shelf support when the rails are rotated to the unfolded position.

### BACKGROUND OF THE INVENTION

1. Field of the Invention

This invention relates to a TV stand assembly that is adapted to be shipped disassembled in a generally flat configuration within a compact container and relatively quickly and easily assembled without the use of tools or special skill. Once the TV stand has been assembled, a television can be retained and selectively positioned at any one of a number of different elevations above the ground to suit the viewing needs of the user.

2. Background Art

Articles of furniture have long been shipped in a fully-assembled condition from a manufacturer to a retailer and then carried off by an end user to a home or office. Consequently, such an article of furniture is characteristically bulky, cumbersome and difficult to transport in a space-efficient manner. That is to say, a fully-assembled article of furniture consumes relatively large shipping space during transport by boat, truck, etc. to a retailer. Similarly, the purchaser/end user may need to have available a specially-sized vehicle should he wish to carry a large article of furniture to his home or office. The inefficient shipment of large articles of furniture between the manufacturer and end user often results in inconvenience as well as significantly higher transportation costs which are commonly passed through to the purchaser.

To overcome the aforementioned disadvantages, it is known to ship articles of furniture disassembled. In this case, the end user is typically required to have available and be able to use at least some hand tools and hardware provided by the manufacturer in order to complete the furniture assembly. Sometimes, the user may not have the skill required to use the tools which may consequently hinder the user's ability to easily assemble and immediately enjoy his furniture. In other cases, the user may lack time and become frustrated which can result in his failure to complete the assembly altogether. Thus, the article of furniture may remain disassembled and eventually have to be returned to its point of purchase.

Accordingly, it would be desirable to have a particular article of furniture (e.g., a folding TV stand assembly) that is adapted to be shipped and transported disassembled in a substantially flat configuration within a compact shipping container and then be relatively quickly and easily assembled without requiring special skill or the use of tools.

### SUMMARY OF THE INVENTION

In general terms, a folding TV stand assembly is disclosed that can be relatively quickly and easily assembled without the use of tools or special skill. Once the TV stand has been assembled, a television can be retained and selectively positioned at any one of a number of different elevations to suit the needs of the viewer. Prior to its assembly, the TV stand assembly is capable of assuming a substantially-flat shipping configuration to facilitate an efficient packaging and transport in a compact container.

The folding TV stand assembly includes a rotatable shelf support, a TV mount, and a back spine which extends between a spine-receiving base of the shelf support and the TV mount. One end of the back spine is removably received by and slidable through the spine-receiving base of the shelf support so that the back spine stands upwardly from the base. The opposite end of the upstanding back spine is detachably connected to the TV mount. The TV mount has a first pair of brackets to be connected to the rear of a television such that the television can be suspended above the shelf support at an elevation that depends upon the slidable receipt of the back spine by the spine-receiving base. The TV mount has a second pair of brackets to enable the TV mount to be connected directly to a wall after it is disconnected from the back spine.

The rotatable shelf support also includes first and second sets of rails. First ends of each set of rails are connected to a pivot pin. Opposite ends of each set of rails are connected to a leg. The pivot pins of the first and second sets of rails are coupled to respective opposite sides of the spine-receiving base of the shelf support. Accordingly, the first and second sets of rails are adapted to rotate at their pivot pins between an unfolded position, where the first and second sets extend outwardly and away from one another, and a folded position, where the first and second sets are disposed in parallel alignment with one another to enable a substantially flat shipping configuration of the folding TV stand assembly. With the first and second sets of rails rotated to the unfolded position, a set of shelves is detachably connected to the shelf support such that each shelf of the set lies one above the other.

### BRIEF DESCRIPTION OF THE DRAWINGS

FIG. 1 shows a folding TV stand assembly in an assembled configuration according to a first preferred embodiment of this invention;

FIG. 2 is an exploded view showing a rotatable shelf support and a set of shelves from the TV stand assembly of FIG. 1, where the shelf support has been rotated to an unfolded position;

FIG. 3 shows the TV stand assembly of FIG. 1 after the rotatable shelf support thereof has been rotated to a folded position;

FIG. 4 shows a folding TV stand assembly according to another preferred embodiment of this invention where an upstanding back spine is detached from a spine-receiving base of the shelf support;

FIG. 5 shows the folding TV stand assembly of FIG. 4 in an assembled configuration with the back spine thereof detachably connected to the spine-receiving base;

FIG. 6 is an exploded view of the folding TV stand assembly of FIG. 1;

FIG. 7 shows one set of rails from the rotatable shelf support of the TV stand assembly of FIG. 6;

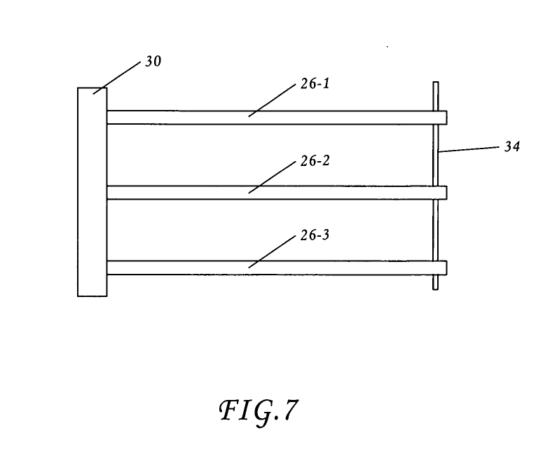

FIG. 8 illustrates the detachable connection of a first TV mount to the back spine of the folding TV stand assembly of FIG. 1;

FIG. 9 is an enlarged detail of the first TV mount taken from FIG. 8;

FIG. 10 is a partially-exploded view of the first TV mount of the folding TV stand shown in FIG. 8;

FIG. 11 illustrates the detachable connection of a second TV mount to the back spine of the folding TV stand assembly of FIG. 4;

FIG. 12 is an enlarged detail of the second TV mount taken from FIG. 11; and

FIG. 13 illustrates the rotatable nature of the second TV mount relative to the back spine of the folding TV stand assembly of FIG. 11.

### DESCRIPTION OF THE PREFERRED EMBODIMENT

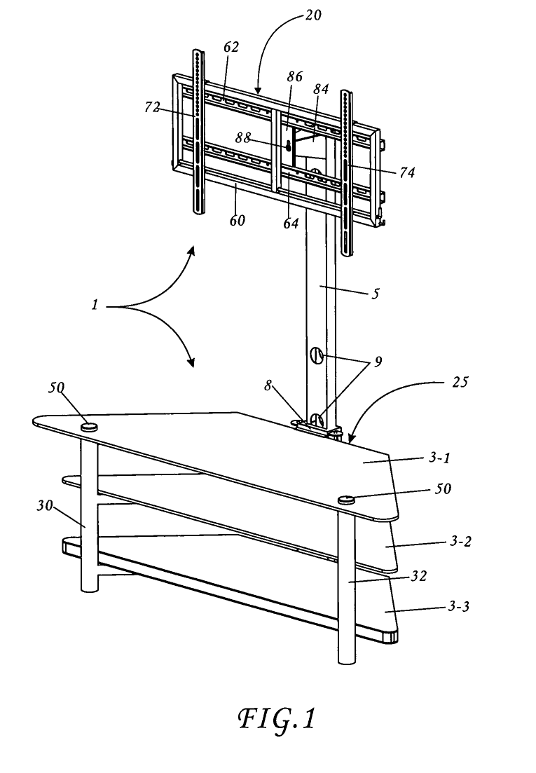

A folding TV stand assembly 1 according to a first preferred embodiment of this invention is initially described while referring to FIGS. 1-3 of the drawings. As will soon be explained, the TV stand assembly 1 has the ability to reliably retain and adjustably position a television at any one of a number of different elevations to suit a viewer's needs. Moreover, the TV stand assembly 1 includes a rotatable shelf support 25 which holds a number of (e.g., three) detachable shelves 3-1, 3-2 and 3-3 upon which a television as well as audio and video electronic devices may be seated for use with or without the television. What is even more, the folding TV stand assembly 1 can be assembled without the use of tools. During shipment, the assembly 1 is adapted to be arranged in a substantially flat configuration to facilitate an efficient packaging and transport in a compact container.

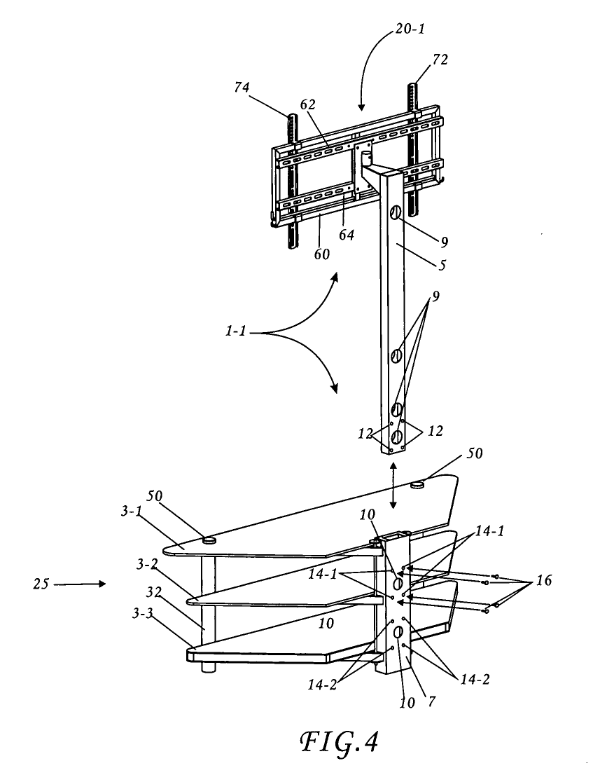

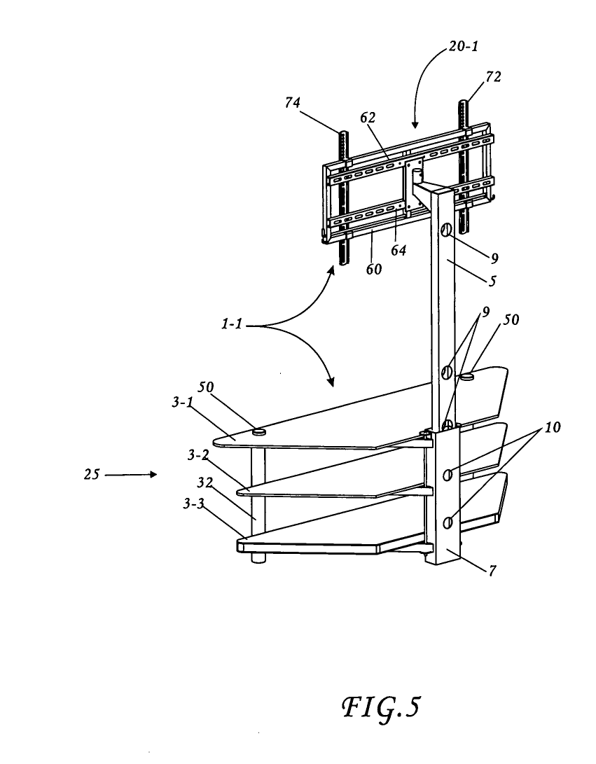

The folding TV stand assembly 1 includes an elongated (e.g., rectangular) hollow back spine 5 that is removably received by and slidable through a hollow spine-receiving base 7 (best shown in FIG. 4) of the rotatable shelf support 25 so that the back spine 5 stands upwardly from base 7. The back spine 5 is removed from the spine base 7 during shipment or at those times when it is desirable to simply lay a television on the top shelf 3-1 rather than suspend the television above the shelf support 25 as will soon be described. A shelf-retaining lip 8, the function of which will also soon be described, projects outwardly from the top of the spine-receiving base 7. Wire management holes 9 are formed through the hollow back spine 5 to accommodate electrical wires and cables between or from the television and any electronic devices that are seated on the shelves of the shelf support 25. Similarly, wire management holes 10 (best shown in FIGS. 4 and 5) are formed through the spine-receiving base 7 to be aligned with respective wire management holes 9 through the back spine 5 in order to permit electrical wires and cables from the television and the electronic devices that are seated on any of the shelves 3-1, 3-2 and 3-3 of shelf support 25 to be connected to a source of electrical power, such as at an electrical wall receptacle.

As is also best shown in FIG. 4, a set of (e.g., four) screw holes 12 are formed through the back spine 5 near the bottom thereof. First and second sets 14-1 and 14-2 of (e.g., four) screw holes are formed one above the other through the spine-receiving base 7. By virtue of the different sets 14-1 and 14-2 of screw holes, the vertical position of the back spine 5 relative to the spine-receiving base 7 may be selectively adjusted to correspondingly adjust the elevation of the television above the shelf support 25 in cases where the television will be suspended above the shelves rather than rest upon the top shelf 3-1. That is, the back spine 5 is pushed or pulled through the spine-receiving base 7 of the shelf support 25 until the set of screw holes 12 formed through back spine 5 are axially aligned with the screw holes from the first and/or second sets 14-1 and 14-2 of screw holes formed through the spine-receiving base 7. A set of (e.g., four) thumb-screws 16 (of FIG. 4) are manually inserted and rotated by hand through the axially-aligned screw holes 12 and 14-1 and/or 14-2 so as to lock the back spine 5 at a desired location within the spine-receiving base 7.

As will be disclosed in greater detail hereinafter, a TV mount 20, which attaches to the back of the television to be elevated by the folding TV stand assembly 1 is removably connected to and suspended from the top of the back spine 5. The vertical position of the TV mount 20 of TV stand assembly 1 above the shelves 3-1 . . . 3-3 is dependent upon the position of the back spine 5 within the spine-receiving base 7 before the back spine 5 and base 7 are interlocked with one another as previously described. The TV mount 20 is disconnected from the back spine 5 during shipping or when it is desirable to affix the TV mount 20 directly to the wall, so that the television will hang from the wall rather than from the TV stand assembly 1.

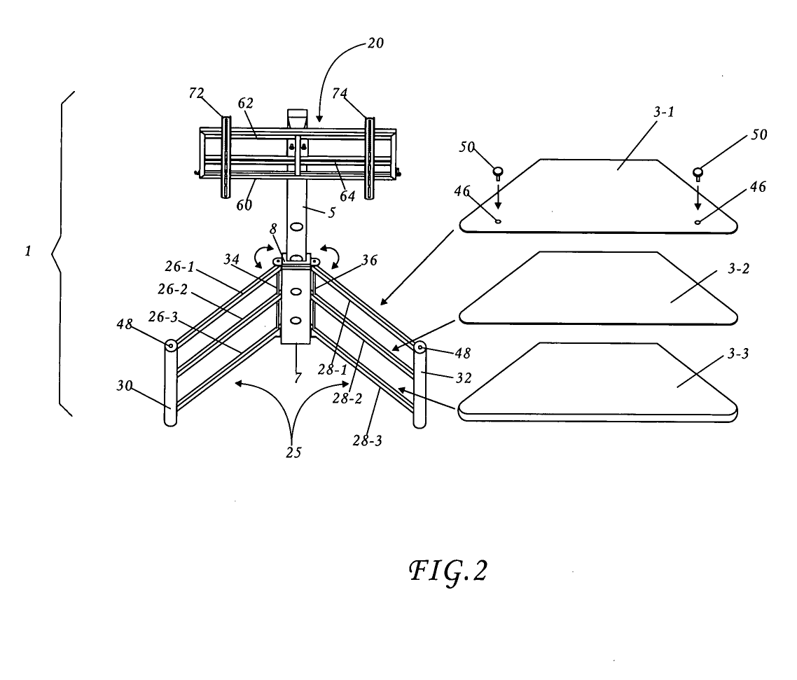

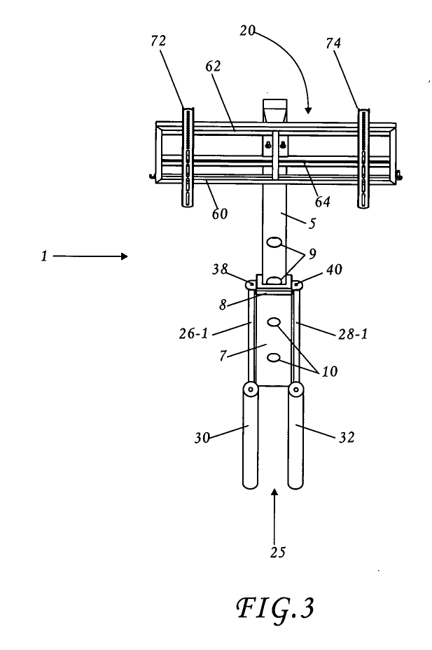

Referring to FIGS. 1-6 of the drawings, details are provided of the rotatable shelf support 25 which holds the detachable shelves 3-1 . . . 3-3 and, when the shelves are detached therefrom, is adapted to be rotated from an outstretched, unfolded position (of FIG. 2) to a space-conserving folded position (of FIG. 3) so as to facilitate the shipment of the disassembled TV stand assembly in the aforementioned substantially flat configuration.

The shelf support 25 of TV stand assembly 1 has a first set 26-1, 26-2 and 26-3 and a second set 28-1, 28-2 and 28-3 of rails. The number of rails 26 and 28 corresponds to the number of shelves 3-1, 3-2 and 3-3 associated with shelf support 25 when the shelf support is in the unfolded position. The rails 26 from the first set are connected at first ends thereof to a cylindrical leg 30. The rails 28 of the second set are connected at first ends thereof to a cylindrical leg 32. The opposite ends of the first set of rails 26 are connected to a first pivot pin 34, and the opposite ends of the second set of rails 28 are connected to a second pivot pin 36.

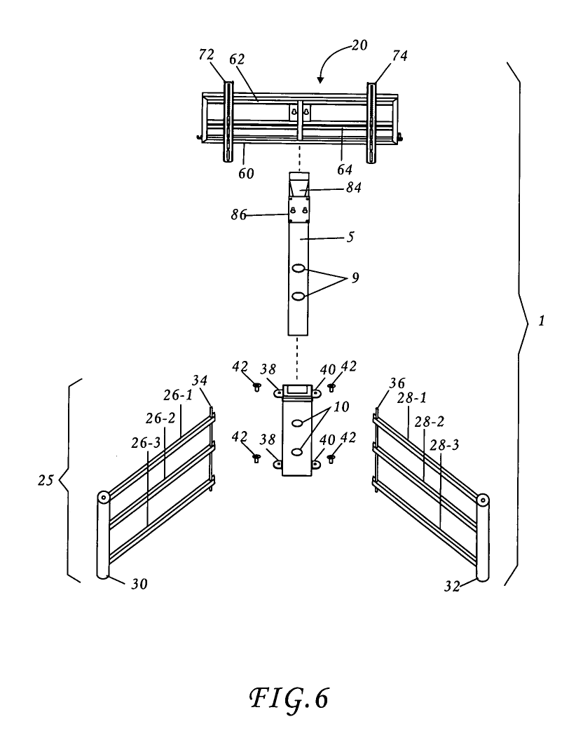

As is best shown in FIG. 6, a pair of spaced, axially-aligned pin-receiving tabs 38 and 40 having pin holes formed therein is located at each side of the spine-receiving base 7 of the rotatable shelf support 25. The pivot pin 34 to which the first set of rails 26 is connected is received by and between the first pair of pin-receiving tabs 38, and the pivot pin 36 to which the second set of rails 28 is connected is received by and between the second pair of pin-receiving tabs 40. Once they are received through the pin holes of the respective pairs of pin-receiving tabs 38 and 40, the pivot pins 34 and 36 are rotatable so as to cause a corresponding rotation of the first and second sets of rails 26 and 28 between the aforementioned unfolded position where the rails 26 and 28 extend outwardly and away from one another and the folded position where the rails are disposed in parallel alignment with each other (best shown in FIG. 3). The pivot pins 34 and 36 may come pre-assembled to the pin-receiving tabs 38 and 40 or, to facilitate a flat package configuration during shipment, disassembled, in which case the user will first slide pins 34 and 36 upwardly through the top most tabs 38 and 40 and then downwardly through the opposing bottom most tabs. A hollow (e.g., nylon) end plug 42 is initially press fit in the pin holes formed through each of the pin-receiving tabs 38 and 40 of the spine-receiving base 7 to provide rotational support for the pivot pins 34 and 36.

Referring particularly to FIG. 2, once the rotatable shelf support 25 is assembled and the rails 26 and 28 thereof are rotated to the unfolded position, the shelves 3-1, 3-2 and 3-3 are mounted on respective pairs of laterally-adjacent rails 26-1, 28-1 and 26-2, 28-2 and 26-3, 28-3. It is contemplated that the top two shelves 3-1 and 3-2 will be manufactured from glass, and the bottom shelf 3-3 will be manufactured from wood, although the material of manufacture is not to be considered a limitation of this invention. Prior to assembly, the shelves 3-1, 3-2 and 3-3 are packaged flat. The first (i.e., top most) shelf 3-1 on which a television may be seated includes a pair of pin holes 46 formed through the front thereof. In the assembled configuration, the pin holes 46 are axially aligned with the legs 30 and 32 of the shelf support 25. Each leg 30 and 32 has a threaded opening 48 at the top within which to receive the threaded pin of a removable end cap 50 via a corresponding pin hole 46 through the shelf 3-1. The end caps 50 are mated to the threaded openings 48 in legs 30 and 32 by means of finger pressure exerted by the user. The back of the top shelf 3-1 located opposite the pin holes 46 is received by and held in place below the shelf-retaining lip 8 of the spine-receiving base 7 (best shown in FIG. 1).

The shelves 3 are preferably attached directly to the first and second sets of rails 26 and 28 of the rotatable shelf support 25 to prevent the shelves from shifting relative to the rails. By way of example only, when the top two shelves 3-1 and 3-2 are manufactured from glass, suction cups (not shown) can be carried by the laterally-adjacent pairs of rails 26-1, 28-1 and 26-2, 28-2 to apply a suction holding force against the shelves 3-1 and 3-2. When the bottom shelf 3-3 is manufactured from wood, the pair of rails 26-3 and 28-3 may include pin holes in which to receive dowel pins or the like (also not shown) which extend from the bottom of shelf 3-3.

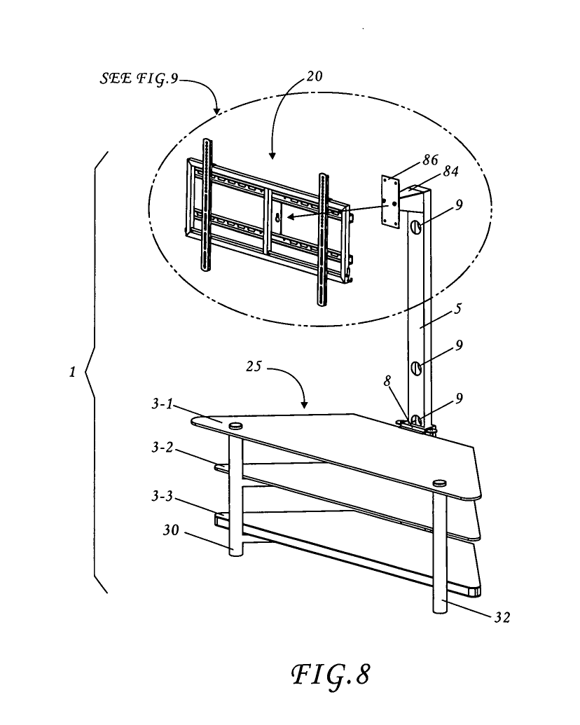

Turning now to FIGS. 8-10 of the drawings, the TV mount 20 is shown detachably connected to the back spine 5 of the TV stand assembly 1 according to one preferred embodiment when it is desirable to suspend a television above the shelves 3-1, 3-2 and 3-3 of the shelf support 25 by way of the removable receipt of the upstanding back spine 5 inwardly of the spine-receiving base 7. Otherwise, as earlier explained, the TV mount 20 can be separated from the back spine 5 and mounted directly to a wall against which to hold the television.

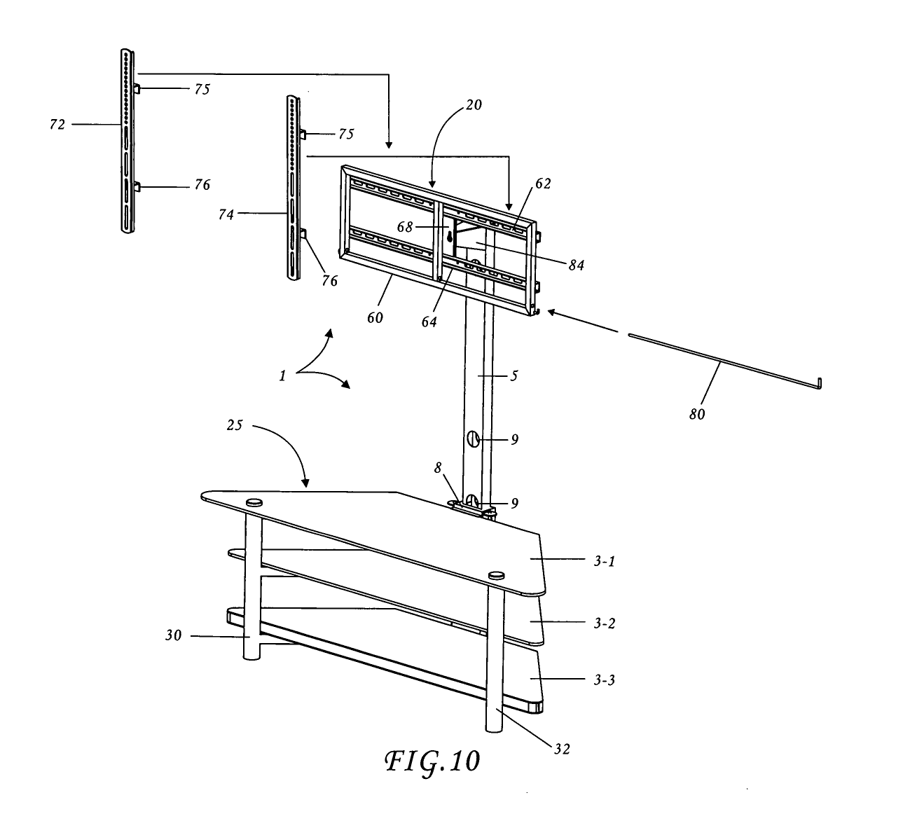

The TV mount 20 shown in FIGS. 8-10 is a commercially-available accessory. Nevertheless, for accuracy, details of the TV mount 20 will be provided. The TV mount 20 includes an open rectangular frame 60. A pair of wall mounting brackets 62 and 64 extend in spaced parallel alignment horizontally across the rear of frame 60. Each wall mounting bracket 62 and 64 has a series of openings 66 formed therethrough by which the mount 20 can be affixed to a wall. A locking plate 68 extends between the wall mounting brackets 62 and 64. The locking plate 68 includes a pair of key-holes 70 (only one of which being visible). Each of a pair of TV mounting brackets 72 and 74 has a pair of upper and lower mounting hooks 75 and 76 extending therefrom to be removably positioned over and in surrounding engagement with the top and bottom of the frame 60. The TV mounting brackets 72 and 74 extend vertically and in spaced parallel alignment with one another across the front of the frame 60. Each of the TV mounting brackets 72 and 74 also has a series of openings 77 formed therethrough to receive suitable fasteners (not shown) by which the TV mounting brackets can be affixed to the back of the television. As is best shown in FIG. 10, a locking rod 80 is pushed laterally through the frame 60 of TV mount 20 so as to extend between the opposite sides thereof by which to slide over and engage the lower mounting hooks 76 of the TV mounting brackets 72 and 74 to prevent a removal of the mounting hooks 76 and a detachment of the mounting brackets from the frame 60.

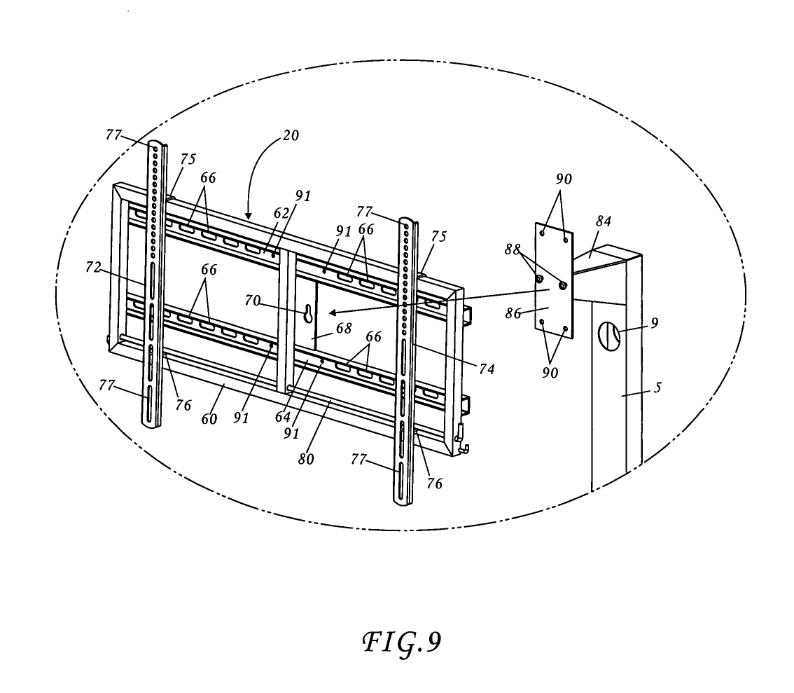

A mounting arm 84 projects outwardly from the top of the back spine 5. The mounting arm 84 carries a vertical back plate 86. A pair of locking button heads 88 projects from the back plate 86 for removable receipt within respective ones of the key holes 70 in the locking plate 68 of TV mount 20. A set of (e.g., four) holes 90 are formed through the back plate 86 to be axially aligned with holes 91 (best shown in FIG. 9) formed in the wall mounting brackets 62 and 64 to removably receive a corresponding set of thumb screws when it is desirable to affix the TV mount 20 to the back spine 5 of TV stand assembly 1 at the back plate 86. With the television attached to the TV mount 20 and the TV mount 20 attached to the back plate 86, the elevation of the television can be selectively adjusted to suit the user's viewing pleasure depending upon the location of the back spine 5 relative to the spine-receiving base 7 (of FIG. 6) within which the back spine is removably received.

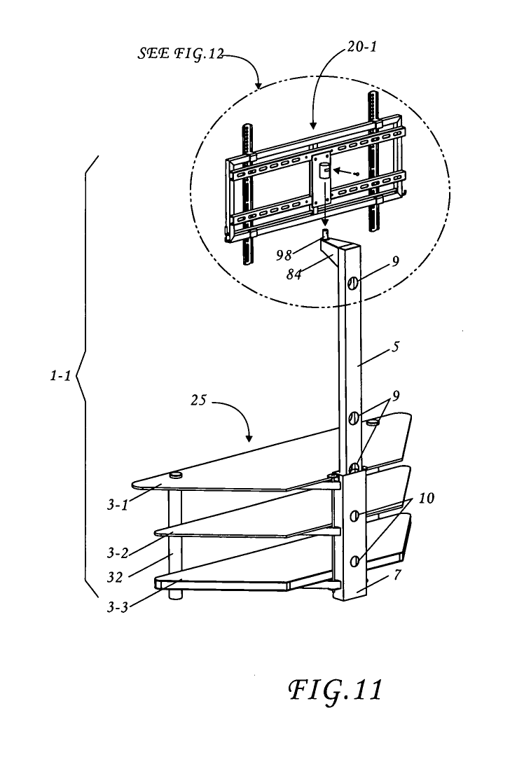

FIGS. 11-13 of the drawings show a modified TV mount 20-1 detachably connected to the back spine 5 of a correspondingly modified TV stand assembly 1-1 according to another preferred embodiment of this invention. The TV mount 20-1 is also a commercially-available accessory. The modified TV mount 20-1 of FIGS. 11-13 has features which are common to the TV mount 20 of FIGS. 8-10. Therefore, identical reference numerals have been used to identify such common features.

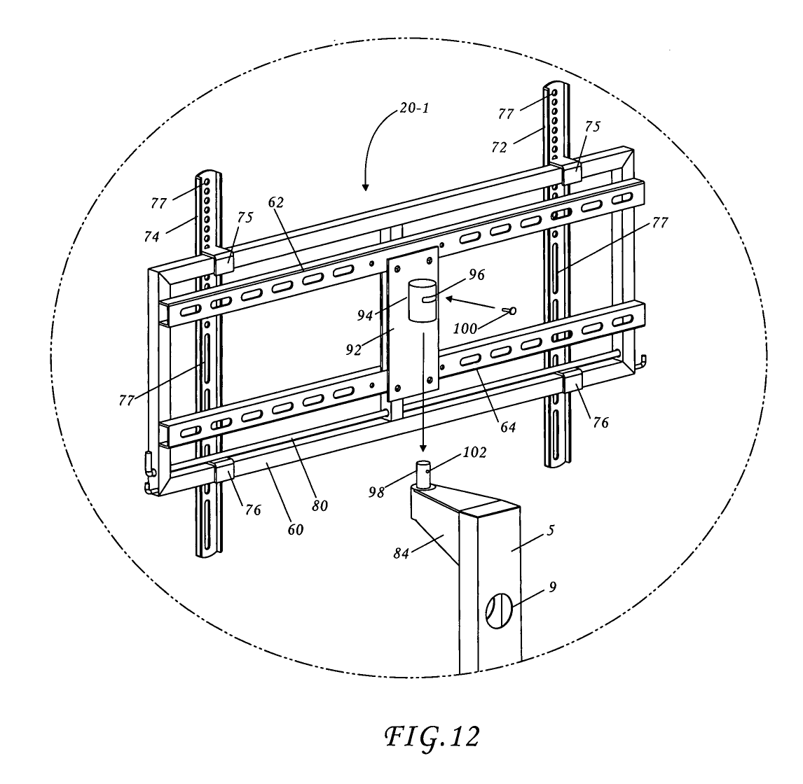

In particular, the TV mount 20-1 includes an open rectangular frame 60. A pair of wall mounting brackets 62 and 64 extends in spaced parallel alignment horizontally across the rear of the frame 60. A locking plate 92 extends between the wall mounting brackets 62 and 64. The locking plate 92 includes a hollow cylindrical coupling sleeve 94 projecting rearwardly therefrom. A locking slot 96 is formed through the coupling sleeve 94 to communicate with the hollow interior thereof. Each of a pair of TV mounting brackets 72 and 74 has a pair of upper and lower mounting hooks 75 and 76 to be removably positioned over and in surrounding engagement with the top and bottom of the frame 60. The TV mounting brackets 72 and 74, which extend vertically and in spaced parallel alignment with one another across the front of the frame 60, have a series of openings 77 through which to receive suitable fasteners (not shown) so that the TV mount 20-1 can be affixed to the back of the television. A locking rod 80 (best shown in FIG. 12) is pushed laterally through the frame 60 of TV mount 20-1 so as to extend between the opposite sides thereof by which to slide over and engage the lower mounting hooks 76 of the TV mounting brackets 72 and 74 to prevent a removal of the mounting hooks 76 and a detachment of the mounting brackets from the frame 60.

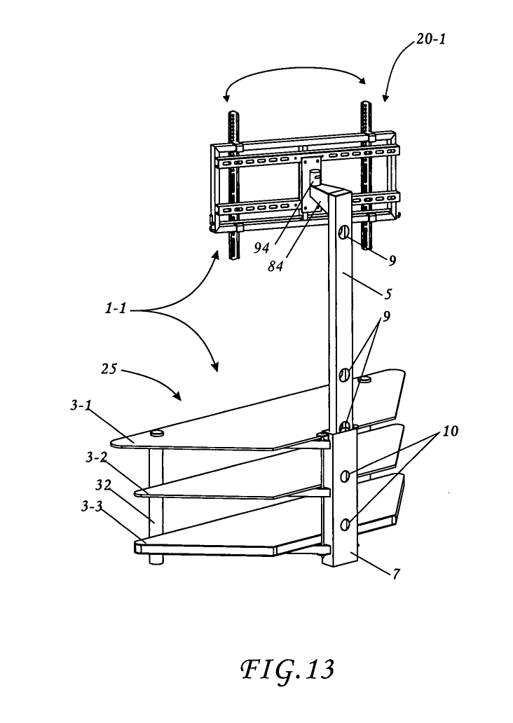

A mounting arm 84 projects outwardly from the top of the back spine 5. A cylindrical coupling mount 98 projects upwardly from the mounting arm 84. The coupling mount 98 is sized and shaped so as to be slidably received within the coupling sleeve 94 at locking plate 92. The coupling sleeve 94 can be rotated around the coupling mount 98 to impart a corresponding rotation to the frame 60 of the TV mount 20-1 (best illustrated at FIG. 13). After the frame 60 has been rotated by the user to position the television carried thereby, a thumb screw 100 is manually inserted and rotated by means of finger pressure through the locking slot 96 of coupling sleeve 94 so as to be tightened within a screw hole 102 that is formed in coupling mount 98, whereby to prevent a further rotation of the frame 60 relative to the back spine 5.

The folding TV stand assemblies 1 and 1-1 herein disclosed are advantageously assembled or disassembled without the use of tools or special skill on the part of the user. Therefore, the assemblies 1 and 1-1 can be completed by the user in a relatively short time compared to the time and inconvenience that might otherwise have been required had conventional tools been needed. Moreover, prior to assembly, the assemblies 1 and 1-1 can be disassembled so as to be laid generally flat and packed in a compact shipping container to reduce transportation costs and facilitate the easy transport of the container by the purchaser to the ultimate point of assembly and use.

1. A TV stand assembly, comprising:
a shelf support having a plurality of rails and a hollow spine receiving base;
at least one shelf removably received by at least some of said plurality of rails of said shelf support;
a TV mount to be connected to a television; and
an upstanding back spine having first and opposite ends, the first end of said back spine removably received by and slidable through the hollow spine-receiving base of said shelf support, and the opposite end of said back spine being detachably connected to said TV mount so that the television to which said TV mount is connected can be suspended a particular distance above said at least one shelf depending upon the distance the first end of said back spine slides through said spine-receiving base,
the plurality of rails of said shelf support adapted to move relative to said spine-receiving base from an unfolded position projecting outwardly and away from one another at which said one shelf is attached to said rail, to a folded position lying in parallel alignment with one another when said shelf is removed from said rails.

2. The TV stand assembly recited in claim 1, wherein said plurality of rails of said shelf support includes first and second sets of rails, first ends of each of said first and second sets of rails being pivotally connected to respective opposite sides of said spine-receiving base such that said first and second sets of rails are rotatable relative to said base between said unfolded position and said folded position.

3. The TV stand assembly recited in claim 2, wherein said shelf support includes a first pivot pin connected to the first ends of the first set of rails and a second pivot pin connected to the first ends of said second set of rails, said first and second pivot pins being pivotally connected to said respective opposite sides of said spine-receiving base to enable said first and second sets of rails to rotate between said unfolded and folded positions.

4. The TV stand assembly recited in claim 3, wherein said first and second pivot pins are removably connected to the opposite sides of said spine-receiving base such that said first and second sets of rails are detachable from said base.

5. The TV stand assembly recited in claim 2, wherein said shelf support includes first and second legs respectively connected to opposite ends of each of said first and second sets of rails, said at least one shelf being detachably connected to said first and second legs.

6. The TV stand assembly recited in claim 5, wherein the spine-receiving base of said shelf support includes a shelf-retaining lip projecting outwardly therefrom and lying above said first and second sets of rails, said at least one shelf being received below and retained by said lip.

7. The TV stand assembly recited in claim 2, further comprising a plurality of shelves, each one of said plurality of shelves being removably received by and seated upon one rail from said first set of rails and one rail from said second set of rails when said first and second sets of rails are rotated to said unfolded position.

8. The TV stand assembly recited in claim 1, wherein each of the hollow spine-receiving base of said shelf support and the first end of said upstanding back spine has screw holes formed therein, at least some of the screw holes of said base and said back spine being axially aligned with one another, said TV stand assembly further comprising thumb screws being rotated by means of finger pressure through said axially-aligned screw holes to releasably connect said back spine to said spine-receiving base without the use of tools.

9. The TV stand assembly recited in claim 1, wherein said TV mount includes a locking plate having at least one keyhole formed therein, and the opposite end of said back spine has at least one button head, said button head moving through and being captured by said keyhole, whereby the opposite end of said back spine is detachably connected to said TV mount.

10. The TV stand assembly recited in claim 9, wherein the opposite end of said back spine also has a mounting arm projecting outwardly therefrom and a back plate carried by said mounting arm, said button head located on said back plate.

11. The TV stand assembly recited in claim 1, wherein said TV mount includes a hollow coupling sleeve and the opposite end of said back spine has a coupling mount, said coupling mount being removably received by said coupling sleeve, whereby the opposite end of said back spine is detachably connected to said TV mount and said TV mount is rotatable relative to said opposite end.

12. The TV stand assembly recited in claim 11, wherein the opposite end of said back spine also has a mounting arm projecting outwardly therefrom, said coupling mount located on said mounting arm.
